(19) United States
(12) Patent Application Publication
(10) Pub. No.: US 2013/0278106 A1
(43) Pub. Date: Oct. 24, 2013

(54) ROTOR ASSEMBLY

(71) Applicants: Changsung Sean Kim, Gyunggi-do (KR); Kwang Hyun Lee, Gyunggi-do (KR); Jae Sung Lee, Gyunggi-do (KR); Hyun Jik Yang, Gyunggi-do (KR); Han Kyung Bae, Gyunggi-do (KR)

(72) Inventors: Changsung Sean Kim, Gyunggi-do (KR); Kwang Hyun Lee, Gyunggi-do (KR); Jae Sung Lee, Gyunggi-do (KR); Hyun Jik Yang, Gyunggi-do (KR); Han Kyung Bae, Gyunggi-do (KR)

(73) Assignee: SAMSUNG ELCTRO-MECHANICS CO., LTD., Gyunggi-do (KR)

(21) Appl. No.: 13/536,473

(22) Filed: Jun. 28, 2012

(30) Foreign Application Priority Data
Apr. 19, 2012 (KR) 1020120040973

(51) Int. Cl. H02K 1/27

(52) U.S. Cl. 310/156.53

(57) ABSTRACT

According to a preferred embodiment of the present invention, in a structure in which a permanent magnet is embedded radially outwardly from a rotor portion, a pair of permanent magnets is embedded in a V-letter shape and a slit in a longitudinal direction is radially formed between the pair of permanent magnets. According to the preferred embodiment of the present invention, it is possible to implement relatively higher torque performance while minimizing the number of permanent magnets embedded in an interior permanent synchronous machine (IPMSM).

### CROSS REFERENCE TO RELATED APPLICATION

This application claims the benefit of Korean Patent Application No. 10-2012-0040973, filed on Apr. 19, 2012, entitled “Rotor Assembly”, which is hereby incorporated by reference in its entirety into this application.

### BACKGROUND OF THE INVENTION

1. Technical Field

The present invention relates to a rotor assembly.

2. Description of the Related Art

Generally, a motor generating a rotation driving power by embedding a permanent magnet into a rotor may be classified into a permanent magnet surface-mounted motor and an interior permanent motor according to a coupling structure of a permanent magnet mounted in a rotor.

As described in Korean Patent Laid-Open Publication No. 2009-0072209, the interior permanent motor may use reluctance torque due a difference between a d-axis (magnetic flux) inductance and a q-axis (torque) inductance in addition to a torque of the permanent magnet by embedding a plurality of permanent magnets in the rotor. In addition, the interior permanent motor may structurally prevent a separation of the permanent magnet that may occur at the time of high-speed rotation and has been more prevalently used than the surface-mounted motor in which the permanent magnet is mounted on a surface of the rotor.

However, the interior permanent motor according to the prior art has problems in using a high-performance permanent magnet, for example, rare-earth magnet components so as to increase a flux amount or obtain high-efficiency torque, additionally forming an interior permanent hole, and limiting a design embedding the permanent magnet so as to maintain rigidity of the rotor portion. Further, there are problems in that when increasing the embedded amount of the permanent magnet, the rigidity of the rotor portion may be weak due to the secure of the embedded space and when a small amount of permanent magnet is embedded, an expensive permanent magnet needs to be used so as to exhibit high performance or performance is degraded at the time of using a general permanent magnet.

In particular, a structural design of a more effective and high-performance flux concentrating motor is urgently needed in the same interior permanent structure.

### SUMMARY OF THE INVENTION

The present invention has been made in an effort to provide a rotor assembly capable of improving a torque value by radially forming slits between a pair of permanent magnets while positioning the pair of permanent magnets in a V-letter shape, in a structure in which the permanent magnets are radially embedded outwardly from a rotor portion.

According to a preferred embodiment of the present invention, there is provided a rotor assembly, including: a rotor portion provided with an embedded hole in which a rotating shaft is embedded; and a first magnet and a second magnet embedded into a first embedded hole and a second embedded hole that are formed at a cross section axially vertical to the shaft of the rotor portion radially outwardly from the rotor portion and formed so that a width of a spaced space increases radially outwardly from the rotor portion from a rotating central shaft of the rotor portion, wherein a slit is formed between the first magnet and the second magnet.

The first magnet and the second magnet may be each embedded along a V letter radially outwardly from the rotor portion, based on the rotating central shaft of the rotor portion as an apex.

The slit may be formed between the first magnet and the second magnet and may be formed by setting the outward radial direction of the rotor part as a longitudinal direction.

Both ends of the first embedded hole and the second embedded hole may be further provided with a leakage preventing gap drawing an arc outwardly from both ends thereof.

At least a pair of first magnets and second magnets may be consecutively formed along an outer circumference of the rotor portion.

According to another preferred embodiment of the present invention, there is provided a rotor assembly, including: a rotor portion provided with an embedded hole into which a rotating shaft is embedded and including a first magnet and a second magnet embedded into a first embedded hole and a second embedded hole formed at a cross section axially vertical to the shaft so that a width of a spaced space increases radially outwardly from the rotor portion 10 based on a rotating central shaft; and a stator portion including at least one stator salient pole formed to correspond to the first magnet and the second magnet of the rotor portion and a stator yoke accommodating the rotor portion, wherein a slit is formed between the first magnet and the second magnet.

The first magnet and the second magnet may be each embedded along a V letter radially outwardly from the rotor portion, based on the rotating central shaft of the rotor portion as an apex.

The slit may be formed between the first magnet and the second magnet and may be formed by setting the outward radial direction of the rotor part as a longitudinal direction

Both ends of the first embedded hole and the second embedded hole may be further provided with a leakage preventing gap drawing an arc outwardly from both ends thereof.

At least a pair of first magnets and second magnets may be consecutively formed along an outer circumference of the rotor portion.

Eight pairs of first magnets and second magnets may be formed along an outer circumference of the rotor portion, and a pair of magnets including the first magnet and the second magnet and six stator salient poles may be formed to face each other.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a rotor assembly according to a preferred embodiment of the present invention;

FIG. 2 is a perspective view of the rotor assembly according to the preferred embodiment of the present invention;

FIG. 3 is a cross-sectional view of a rotor assembly according to another preferred embodiment of the present invention;

FIG. 4 is a perspective view of the rotor assembly according to another preferred embodiment of the present invention;

FIG. 5A is a cross-sectional view of the rotor assembly according to the preferred embodiment of the present invention and FIG. 5B is a cross-sectional view of the rotor assembly according to a comparison embodiment;

FIGS. 6A and 6B are graphs of torque values according to each phase change shown in FIGS. 5A and 5B; and

FIGS. 7A and 7B are graphs of cogging torque values according to each phase change shown in FIGS. 5A and 5B.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

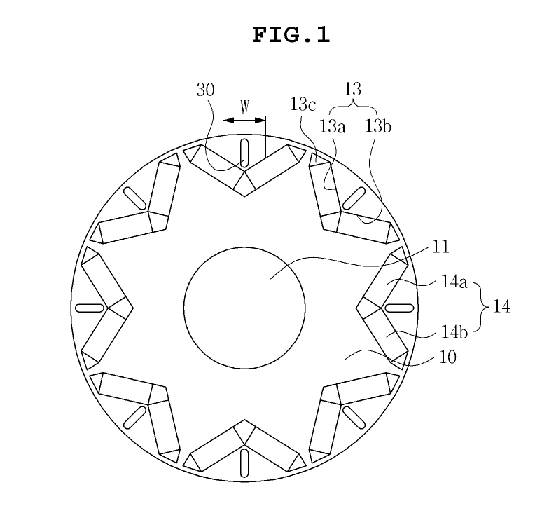

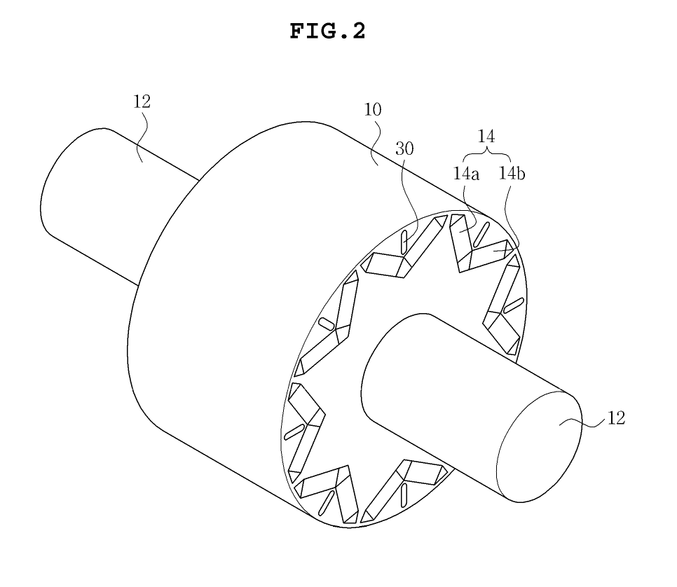

FIG. 1 is a cross-sectional view of a rotor assembly according to a preferred embodiment of the present invention and FIG. 2 is a perspective view of the rotor assembly according to the preferred embodiment of the present invention.

The rotor assembly according to a preferred embodiment of the present invention may include: a rotor portion 10 provided with an embedded hole 11 in which a rotating shaft 12 is embedded; and a first magnet 14a and a second magnet 14b embedded into a first embedded hole 13a and a second embedded hole 13b that are formed at a cross section axially vertical to the shaft 12 of the rotor portion 10 radially outwardly from the rotor portion 10 and formed so that a width w of a spaced space increases radially outwardly from the rotor portion 10 from a rotating central shaft of the rotor portion 10, wherein a slit 30 may be formed between the first magnet 14a and the second magnet 14b.

A hollow portion of the rotor portion 10 is provided with the embedded hole 11 into which the rotating shaft 12 may be embedded. The rotor portion 10 may be generally formed in a cylindrical member and may be embedded with the shaft 12 or integrally formed with the shaft 12 so that the rotor portion 10 may be mounted at the outside of the housing (not shown) to axially rotate with a general housing (see FIG. 2). The present invention relates to the rotor portion 10 in which the magnet 14 is embedded. Hereinafter, the magnet 14 may use a permanent magnet, such as a ferrite permanent magnet, a rare-earth permanent magnet, an alnico permanent magnet. In particular, a rare-earth permanent magnet may include SmCo and NdFeB, wherein the SmCo may have high residual magnetic flux density, coercive force, and energy product and temperature coefficients such as demagnetizing curve and NdFeB may have residual magnetic flux density and coercive force characteristics higher than the SmCo. In particular, the interior magnet structure including the slit 30 according to the preferred embodiment of the present invention can more effectively secure the flux amount, improve the operation performance of the rotor assembly, and secure the reliability of driving due to the embedding of a small amount of magnet 14. Therefore, according to the preferred embodiment of the present invention, various substitute permanent magnets in addition to the high-performance rare-earth permanent magnet can be used and the rigidity of the rotor portion 10 can be maintained by minimizing the embedded hole 13 into which the magnet 14 is embedded.

The magnet 14 is embedded into the embedded hole 13 that is formed on a cross section of the rotor part 10 axially vertical to the shaft 12. The embedded hole 13 may be formed to correspond to the shape of the magnet 14. In the preferred embodiment of the present invention, at least one pair of the first magnet 14a and the second magnet 14b embedded into the first embedded hole 13a and the second embedded hole 13b may be formed at the outer circumferential surface of the rotor portion 10. In particular, a first magnet 14a and a second magnet 14b are radially embedded outwardly from the rotor portion 10 in a V-letter shape and the slit 30 may be formed between the first magnet 14a and the second magnet 14b. In detail, as shown in FIG. 1, the first magnet 14a and the second magnet 14b are disposed so that the spaced space between the first magnet 14a and the second magnet 14b radially disposed outwardly from the rotor portion 10 gradually increases, based on a rotating central shaft of the rotor portion 10 as an apex. That is, the first magnet 14a and the second magnet 14b are embedded along a V-letter based on the rotating central shaft of the rotor portion as an apex. At least of the first magnet 14a and the second magnet 14b may be formed at the outer circumferential surface of the rotor portion 10 by using a pair of the first magnet 14a and the second magnet 14b as a minimum unit. In this case, the first magnet 14a and the second magnet 14b may be magnetized in the same direction by making both of them into N pole or S pole radially outwardly therefrom. For example, when a pair of the first magnet 14a and the second magnet 14b is magnetized so that the outward radial direction of the rotor portion 10 is an N pole, another pair of adjacent magnets 14 is magnetized so that the outward radial direction of the rotor portion 10 is an S pole. At least one pair of the first magnet 14a and the second magnet 14b may be consecutively magnetized in this order.

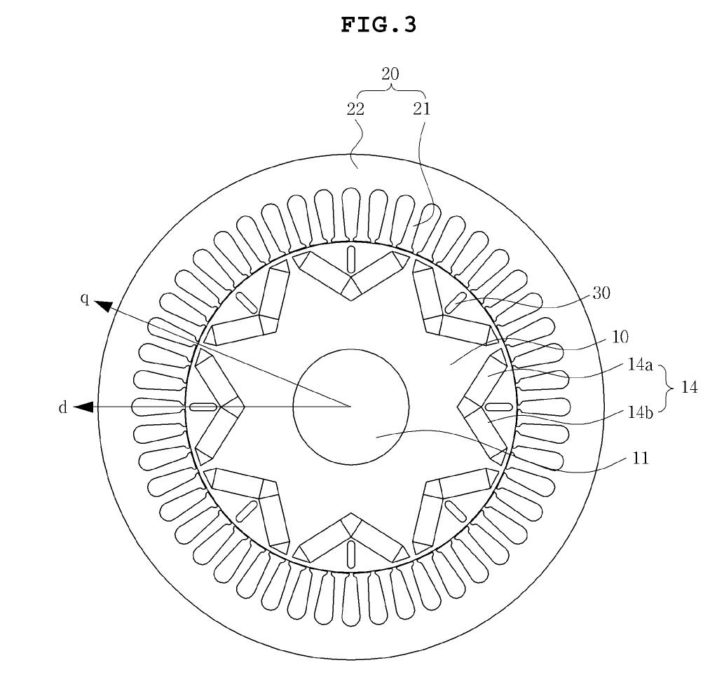

The slit 30 may be formed between the first magnet 14a and the second magnet 14b. As shown in FIG. 1, the slit 30 may be formed by setting the outward radial direction of the rotor part 10 as a longitudinal direction. The slit 30 may be formed to pass through the centers of the first magnet 14a and the second magnet 14b when the first magnet 14a and the second magnet 14b are embedded in a V-letter shape. However, event though the slit 30 does not pass through the central line of the width w of the spaced space of the first magnet 14a and the second magnet 14b, the present invention can be applied when the outward radial direction of the rotor portion 10 is set as the longitudinal direction. In detail, as shown in FIG. 3, when the flux flows due to the combination of the rotor portion 10 and the stator port 20 to be described below, the flow of flux in the q-axis direction is interrupted through the slit 30 such that the flow of flux in a d-axis direction is more efficiently concentrated, thereby improving the efficiency such as the motor, or the like, including the rotor assembly.

Both ends of the first embedded hole 13a and the second embedded hole 13b may be further provided with a leakage preventing gap 13c drawing an arc outwardly from both ends thereof. The leakage preventing gap 13c may be formed to prevent the leakage of flux due to the magnet 14 embedded into the embedded hole 13.

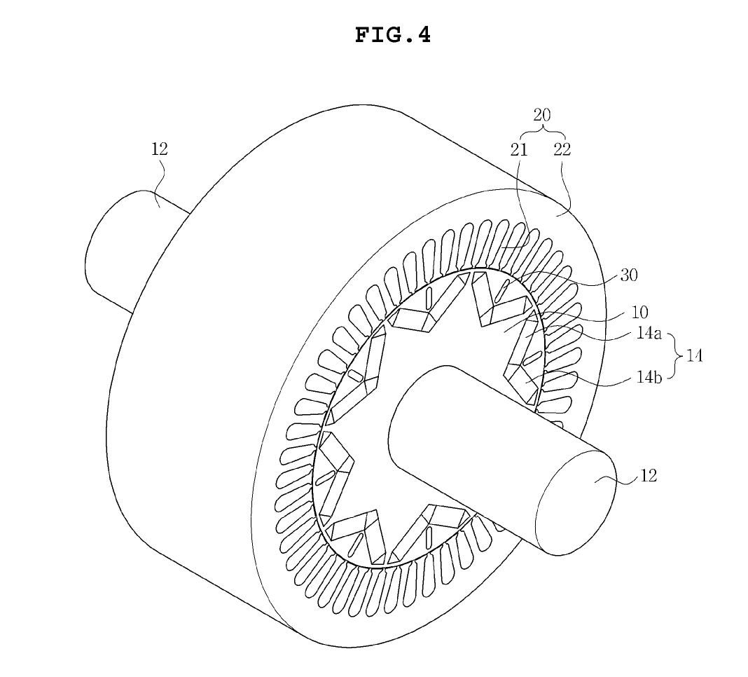

FIG. 3 is a cross-sectional view of a rotor assembly according to another preferred embodiment of the present invention and FIG. 4 is a perspective view of the rotor assembly according to another preferred embodiment of the present invention.

A rotor assembly according to another embodiment of the present invention includes: a rotor portion 10 provided with the embedded hole 11 into which the rotating shaft 12 is embedded and including the first magnet 14a and the second magnet 14b embedded into the first embedded hole 13a and the second embedded hole 13b formed at a cross section axially vertical to the shaft 12 so that the width w of the spaced space increases radially outwardly from the rotor portion 10 from the rotating central shaft; and a stator portion 20 including at least one stator salient pole 21 formed to correspond to the first magnet and the second magnet 14b of the rotor portion 10 and a stator yoke 22 accommodating the rotator portion 10, wherein the slit 30 may be formed between the first magnet 14a and the second magnet 14b.

In another preferred embodiment of the present invention, each component and effects of the rotor portion 10, the embedded hole 13 embedded into the rotor portion, and the magnet are the same as the preferred embodiment of the present invention and the detailed description thereof will be omitted.

The rotor portion 10 is provided with the embedded hole 11 into which the rotating shaft 12 is embedded and at least one magnet 14 is embedded into the embedded hole 13 in a V-letter shape radially outwardly from the rotor portion 10 based on the embedded hole 11. The rotor portion 10 with which the shaft 12 is coupled is the same as the drawings of FIGS. 1 and 2 and each description, configuration, and acting effect, and the like thereof and therefore, the description thereof will be omitted.

The stator portion 20 may include at least one stator salient pole 21 and the stator yoke 22 accommodating the rotor portion 10 formed to correspond to the magnet 14 of the rotor portion 10. The stator portion 20 is generally formed in an annular shape formed to surround the rotor portion 10 and may be changed and selectively applied by those skilled in the art according to a structure of a device in which the rotor assembly is mounted. As shown in FIG. 4, the stator portion 20 is formed to surround the outer circumference of the rotor portion 10. The stator portion 20 is configured to include the stator yoke 22 and the stator salient pole 21. The annular stator yoke 22 formed to surround the outside of the rotor portion 10 is coupled with at least one stator salient pole 21 that is protrudedly formed at the inner circumferential surface of the stator yoke 22 and having a coil wound therearound. As shown in FIG. 3, even in the preferred embodiment of the present invention, the first magnet 14a and the second magnet 14b embedded into the rotor portion may embedded in the V-letter shape so that the spaced space w may increase radially outwardly from the rotor portion 10. Other detailed description is the same as the preferred embodiment described above and therefore, the description thereof will be omitted.

In particular, as shown in FIG. 4, eight pairs of first magnets 14a and second magnets 14b are formed along the outer circumference of the rotor portion 10 and a pair of magnets formed of the first magnet 14a and the second magnet 14b and six stator salient poles 21 may be formed to face each other. That is, the rotor assembly may be formed in the state in which eight poles of the rotor portion 10 and 48 stator poles 21 of the stator portion 20 are combined with each other. However, the combination ratio is described as one preferred embodiment and the rotor portion 10 and it can be apparent to those skilled in the art that the stator portion 20 can be combined according to various combinations for the efficiency of the motor, and the like, including the rotor assembly.

Hereinafter, a difference in the torque value and the cogging torque value between the rotor assembly according to the preferred embodiment of the present invention and the comparison embodiment will be described through graphs with reference to each drawing.

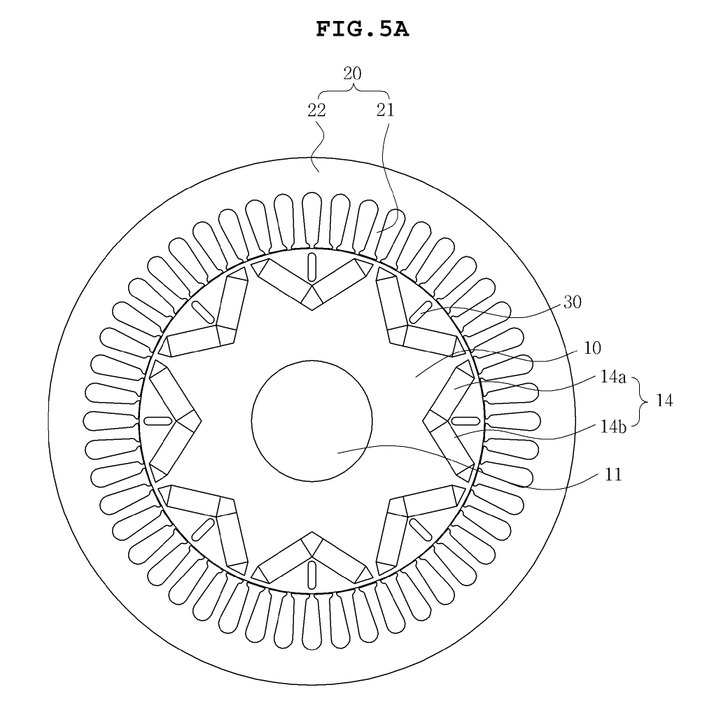

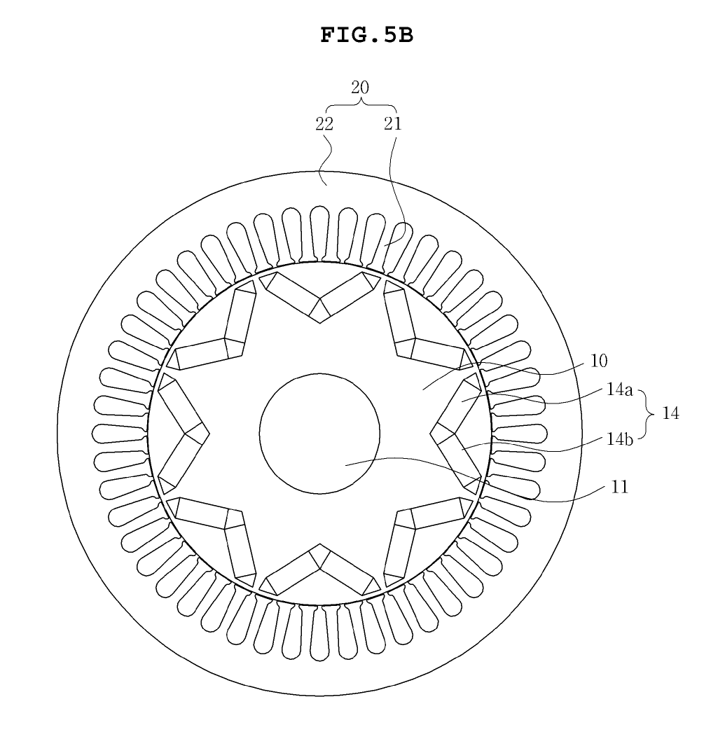

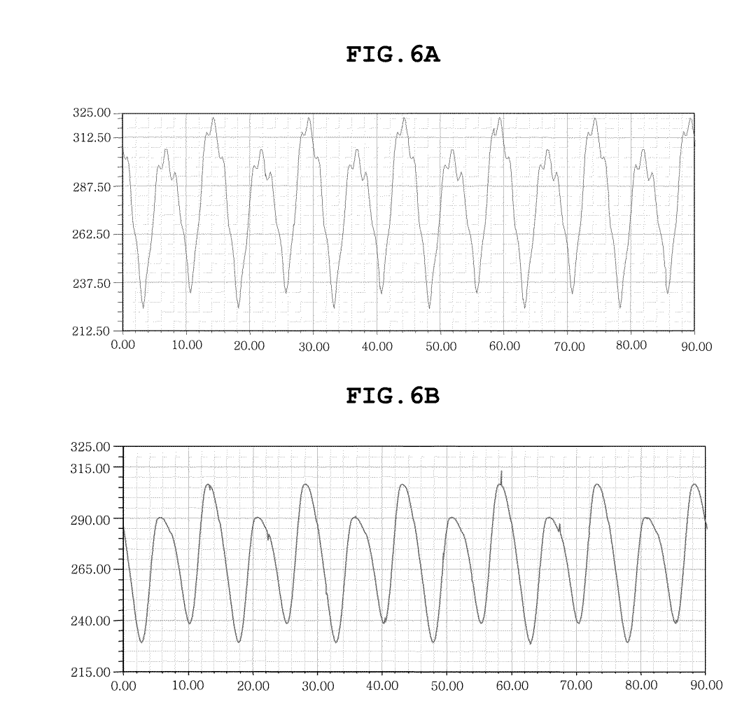

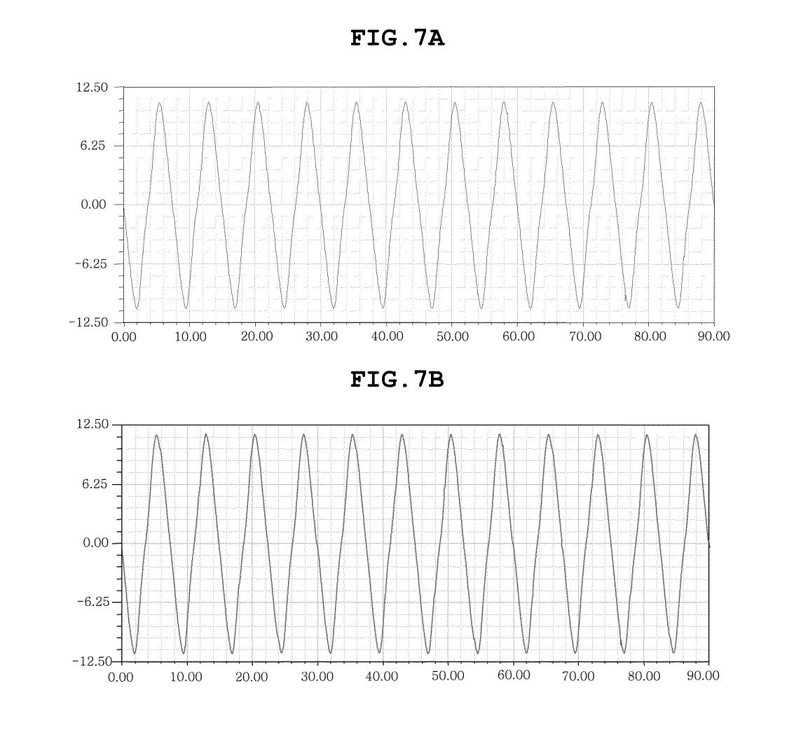

FIG. 5A is a cross-sectional view of the rotor assembly according to the preferred embodiment of the present invention and FIG. 5B is a cross-sectional view of the rotor assembly according to a comparison embodiment. FIGS. 6A and 6B are graphs of torque values according to each phase change shown in FIGS. 5A and 5B and FIGS. 7A and 7B are graphs of cogging torque values according to each phase change shown in FIGS. 5A and 5B.

In addition, an X axis of each graph represents a machine angle in which the rotor assembly including the stator portion 20 rotates and a Y axis represents the torque value and the cogging torque value. That is, the Y-axis value in FIGS. 6A and 6B represent torque values (N·m) and in FIGS. 7A and 7B, a Y-axis value represent the cogging torque value (N·m).

FIG. 5A shows the case in which the slit is formed between the first magnet and the second magnet according to the preferred embodiment of the present invention and FIG. 5B is a cross-sectional view of the rotor assembly of the magnet structure that does not include the slit as the comparison embodiment of the present invention.

FIG. 6A is a graph showing the phase change and the torque value according to the interior structure of the magnet 14 according to the preferred embodiment of the present invention of FIG. 5A and FIG. 6B is a graph showing the phase change and the torque value according to the interior structure of the magnet 14 of the comparison embodiment of FIG. 5B.

As shown in FIG. 6A, it can be appreciated that an average value of the torque value according to the phase change according to the preferred embodiment of the present invention is approximately 325 N·m. On the other hand, as shown in FIG. 6B, the average value of the torque value according to the phase change of the comparison embodiment is approximately 300 N·m and it can be appreciated that the structure according to the preferred embodiment of the present invention shows more improved torque values through the concentration of the flux amount.

FIG. 7A is a graph showing the phase change and the cogging torque value according to the interior structure of the magnet 14 according to the preferred embodiment of the present invention of FIG. 5A and FIG. 7B is a graph showing the phase change and the cogging torque value according to the interior structure of the magnet 14 of the comparison embodiment of FIG. 5B.

As shown in FIG. 7A, it can be appreciated that a width between a maximum value and a minimum value of the cogging torque value according to the phase change according to the preferred embodiment of the present invention is approximately 21.96N·m. On the other hand, as shown in FIG. 7B, the width between the maximum value and the minimum value of the cogging torque value according to the phase change of the comparison embodiment is approximately 23. 16 N·m and it can be appreciated that the cogging torque value is more reduced in the structure including the slit 30 according to the preferred embodiment of the present invention.

The cogging torque is the radial force moving to the position (equilibrium state) at which the magnetic energy of the motor system is minimum, which is generated by the interaction of the stator salient pole 21 of the stator portion 20 and the pole of the corresponding rotor portion 10 As the cogging torque value is reduced, the rotation of the motor is smooth and the driving efficiency of the motor may be improved.

According to the preferred embodiment of the present invention, it is possible to implement the relatively higher torque performance while minimizing the number of permanent magnets embedded in the interior permanent synchronous machine (IPMSM).

Further, the permanent magnets according to the preferred embodiments of the present invention are formed radially from the rotor portion but the pair of permanent magnets is embedded in a V-letter shape and the radial slits are formed between the pair of interior magnets, thereby concentrating flux and improving the torque performance.

In addition, it is possible to reduce the cogging torque by radially forming the slits between the permanent magnets embedded in a V-letter shape formed in the rotor portion.

Further, it is possible to improve the operation performance of the rotor assembly including the rotor portion and the reliability of the driving by concentrating the flux to the radial slits formed in the rotor portion.

Moreover, it is possible to form the small amount of permanent magnet embedding hole and more improve the rigidity of the rotor portion together with the high efficiency by effectively forming the concentration of the flux amount of the interior permanent magnet, by using the interior permanent synchronous machine having the same structure.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A rotor assembly, comprising:
a rotor portion provided with an embedded hole in which a rotating shaft is embedded; and
a first magnet and a second magnet embedded into a first embedded hole and a second embedded hole that are formed at a cross section axially vertical to the shaft of the rotor portion radially outwardly from the rotor portion and formed so that a width of a spaced space increases radially outwardly from the rotor portion from a rotating central shaft of the rotor portion,
wherein a slit is formed between the first magnet and the second magnet.

2. The rotor assembly as set forth in claim 1, wherein the first magnet and the second magnet are each embedded along a V letter radially outwardly from the rotor portion, based on the rotating central shaft of the rotor portion as an apex.

3. The rotor assembly as set forth in claim 1, wherein the slit is formed between the first magnet and the second magnet and is formed by setting the outward radial direction of the rotor part as a longitudinal direction.

4. The rotor assembly as set forth in claim 1, wherein both ends of the first embedded hole and the second embedded hole are further provided with a leakage preventing gap drawing an arc outwardly from both ends thereof.

5. The rotor assembly as set forth in claim 1, wherein at least a pair of first magnets and second magnets are consecutively formed along an outer circumference of the rotor portion.

6. A rotor assembly, comprising:
a rotor portion provided with an embedded hole into which a rotating shaft is embedded and including a first magnet and a second magnet embedded into a first embedded hole and a second embedded hole formed at a cross section axially vertical to the shaft so that a width of a spaced space increases radially outwardly from the rotor portion 10 based on a rotating central shaft; and
a stator portion including at least one stator salient pole formed to correspond to the first magnet and the second magnet of the rotor portion and a stator yoke accommodating the rotor portion,
wherein a slit is formed between the first magnet and the second magnet.

7. The rotor assembly as set forth in claim 6, wherein the first magnet and the second magnet are each embedded along a V letter radially outwardly from the rotor portion, based on the rotating central shaft of the rotor portion as an apex.

8. The rotor assembly as set forth in claim 6, wherein the slit is formed between the first magnet and the second magnet and is formed by setting the outward radial direction of the rotor part as a longitudinal direction.

9. The rotor assembly as set forth in claim 6, wherein both ends of the first embedded hole and the second embedded hole are further provided with a leakage preventing gap drawing an arc outwardly from both ends thereof.

10. The rotor assembly as set forth in claim 6, wherein at least a pair of first magnets and second magnets are consecutively formed along an outer circumference of the rotor portion.

11. The rotor assembly as set forth in claim 6, wherein eight pairs of first magnets and second magnets are formed along an outer circumference of the rotor portion, and
a pair of magnets including the first magnet and the second magnet and six stator salient poles are formed to face each other.
